(19) United States
(12) Patent Application Publication
(10) Pub. No.: US 2019/0143891 A1
(43) Pub. Date: May 16, 2019

(54) ALERT CONTROL APPARATUS, ALERT CONTROL METHOD, AND RECORDING MEDIUM

(71) Applicant: OMRON Corporation, Kyoto-shi (JP)

(72) Inventors: Tomoyoshi AIZAWA, Kyoto-shi (JP); Tadashi HYUGA, Hirakata-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/143,388

(22) Filed: Sep. 26, 2018

(30) Foreign Application Priority Data
Nov. 15, 2017 (JP) 2017-219782

(51) Int. Cl. B60Q 9/00; G06K 9/00; G08G 1/16

(52) U.S. Cl. CPC B60Q 9/00; B60Q 5/005; G08G 1/161; G06K 9/00818

(57) ABSTRACT

An alert may not be generated at railroad crossings. An alert control apparatus (300) includes data obtaining units (41 to 43) that obtain sensing data (a to j) from sensors (6 to 15), a railroad crossing recognizer (44) that recognizes the position of a railroad crossing relative to a vehicle based on the sensing data, and a criterion changer (46) that changes, based on the recognition result, a determination criterion used by a distracted driving alert device (200) to generate an alert to distracted driving to a criterion with which the alert is more likely to be generated while the vehicle is passing the railroad crossing than at other times.

### CROSS-REFERENCE TO RELATED APPLICATION

This application claims priority to Japanese Patent Application No. 2017-219782 filed on Nov. 15, 2017, the entire disclosure of which is incorporated herein by reference.

### FIELD

The present invention relates to an alert control apparatus for controlling an alert device that alerts a driver of a vehicle, an alert control method, and a recording medium.

### BACKGROUND

A known alert device alerts a vehicle driver to distracted driving to prompt safety checking. This type of alert device generates an alert when, for example, determining that the driver is looking aside longer than an allowable duration. However, an alert can sometimes be annoying, or rather dangerous for a driver moving his or her gaze to check the surroundings for safety. Techniques have thus been developed to appropriately alert the driver to distracted driving. For example, Patent Literature 1 describes a technique for changing the detection sensitivity of distracted driving depending on the traveling speed of the vehicle and the distance from a vehicle traveling ahead.

### CITATION LIST

### Patent Literature

Patent Literature 1: Japanese Unexamined Patent Application Publication No. 2001-138767

### SUMMARY

### Technical Problem

Existing techniques set a relatively long duration for which distracted driving is allowed for a vehicle traveling far from a preceding vehicle at a low speed. However, this setting may not be effective in some situations. For example, a driver slows down the vehicle at a railroad crossing to check the surroundings more carefully, for which a longer allowable duration for distracted driving will be set. An alert may not be generated when appropriate.

One or more aspects of the present invention are directed to an alert control apparatus, an alert control method, and an alert control program that enable appropriate alert generation at railroad crossings.

### Solution to Problem

In response to the above issue, the aspects of the present invention may be implemented in the manner described below.

An alert control apparatus according to a first aspect of the present invention is installable in a vehicle to control an alert device that alerts a driver. The apparatus includes a data obtaining unit that obtains sensing data from a sensor included in the vehicle, a gaze detector that detects a gaze or a face orientation of the driver based on the obtained sensing data, a distracted driving determiner that determines distracted driving of the driver based on the detected gaze or face orientation and a determination criterion for detecting distracted driving of the driver, a controller that causes the alert device to generate an alert in response to detection of distracted driving, a railroad crossing recognizer that recognizes a position of a railroad crossing relative to the vehicle based on the obtained sensing data, and a changer that changes, based on a recognition result from the railroad crossing recognizer, the determination criterion to a criterion with which the alert is more likely to be generated while the vehicle is passing the railroad crossing than at other times.

An alert control apparatus according to a second aspect of the present invention is the alert control apparatus according to the first aspect in which the determination criterion is changeable based on at least a speed of the vehicle or a distance from a preceding vehicle, and the changer changes the determination criterion based on the recognition result from the railroad crossing recognizer with precedence over the speed of the vehicle and the distance from the preceding vehicle.

An alert control apparatus according to a third aspect of the present invention is the alert control apparatus according to the first aspect in which the determination criterion includes a retention allowable duration for which the driver is allowed to retain a gaze or a face orientation within a determinant area imaginarily defined for detecting distracted driving, and the changer shortens the retention allowable duration to retain the gaze or the face orientation of the driver within the determinant area while the vehicle is passing the railroad crossing from a retention allowable duration used at other times.

An alert control apparatus according to a fourth aspect of the present invention is the alert control apparatus according to the first aspect further including a storage that stores map data including at least position data about the railroad crossing, in which the sensing data includes position data about the vehicle. The data obtaining unit obtains the position data about the vehicle based on a positioning signal from a positioning system. The railroad crossing recognizer recognizes the position of the railroad crossing relative to the vehicle based on the obtained position data about the vehicle and the position data about the railroad crossing included in the map data.

An alert control apparatus according to a fifth aspect of the present invention is the alert control apparatus according to the first aspect in which the vehicle includes an exterior view camera that obtains image data external to the vehicle, the data obtaining unit obtains the image data from the exterior view camera, and the railroad crossing recognizer subjects the image data to image processing and uses the processed image data to recognize the position of the railroad crossing relative to the vehicle.

An alert control apparatus according to a sixth aspect of the present invention is the alert control apparatus according to the first aspect in which the vehicle is configured to communicate with a vehicle-to-roadside communication system or a vehicle-to-vehicle communication system, the data obtaining unit obtains surrounding data about the vehicle from the communication system, and the railroad crossing recognizer recognizes the position of the railroad crossing relative to the vehicle based on the surrounding data.

An alert control method according to a seventh aspect of the present invention is implemented by an alert control apparatus installable in a vehicle to control an alert device that alerts a driver. The method includes obtaining, with the alert control apparatus, sensing data from a sensor included in the vehicle, detecting, with the alert control apparatus, a gaze or a face orientation of the driver based on the obtained sensing data, determining, with the alert control apparatus, distracted driving of the driver based on the detected gaze or face orientation and a determination criterion for detecting distracted driving of the driver, causing, with the alert control apparatus, the alert device to generate an alert in response to detection of distracted driving, recognizing, with the alert control apparatus, a position of a railroad crossing relative to the vehicle based on the obtained sensing data, and changing, with the alert control apparatus, based on a recognition result from the railroad crossing recognizer, the determination criterion to a criterion with which the alert is more likely to be generated while the vehicle is passing the railroad crossing than at other times.

A recording medium according to an eighth aspect of the present invention has a program causes a computer to implement processes performed by the units included in the alert control apparatus according to any one of the first to sixth aspects.

### Advantageous Effects

The apparatus, method, and recording medium according to the first, seventh, and eighth aspects change the determination criterion used by the alert device to generate an alert to distracted driving to a criterion with which the alert is more likely to be generated while the vehicle is passing a railroad crossing than at other times. This structure generates an alert to distracted driving more frequently than at usual times. An alert to distracted driving prompts the driver at a railroad crossing to change his or her gaze or face orientation, or specifically to look in multiple directions for safety checking. The structure can thus improve the safety of the vehicle passing a railroad crossing.

The apparatus according to the second aspect changes, although the determination criterion for generating an alert to distracted driving has been relaxed in response to, for example, a lower vehicle speed, the determination criterion upon recognition of a railroad crossing with precedence over the above setting. More specifically, the distracted driving determination is performed while the vehicle is passing a railroad crossing with precedence over the distracted driving determination based on the vehicle speed. This structure avoids contention of the multiple determination criteria, and more reliably improves the safety of the vehicle passing a railroad crossing.

The apparatus according to the third aspect shortens the retention allowable duration for which the driver is allowed to retain his or her gaze or face orientation within the area imaginarily defined for detecting distracted driving while the vehicle is passing a railroad crossing from the retention allowable duration used at other times. This prompts the driver to frequently move his or her gaze in multiple directions, and improves the safety of the vehicle passing a railroad crossing.

The apparatus according to the fourth aspect obtains the position data about the vehicle based on the positioning signal provided by a positioning system, and recognizes the position of a railroad crossing relative to the vehicle based on the position data about the vehicle and the position data about the railroad crossing included in the prestored map data. This structure recognizes a railroad crossing with higher accuracy by using an existing positioning system, which may be a global positioning system (GPS).

In the apparatus according to the fifth aspect, the exterior view camera installed in the vehicle obtains the exterior image data, which is used to recognize the position of a railroad crossing relative to the vehicle. This structure recognizes a railroad crossing without relying on an external resource, such as a positioning system, and thus may include no positioning system or receive no positioning signal.

The apparatus according to the sixth aspect obtains the surrounding data about the vehicle from a vehicle-to-roadside communication system, which is used to recognize the position of a railroad crossing relative to the vehicle. The simple structure can recognize a railroad crossing by, for example, receiving information about the location of a railroad crossing from a vehicle-to-roadside communication system, which may typically be the Vehicle Information and Communication System (VICS, registered trademark), or with a radio wave beacon installed near a railroad crossing.

### BRIEF DESCRIPTION OF THE DRAWINGS

FIG. 1A is a schematic diagram describing an example use of an alert control apparatus according to one or more embodiments of the present invention;

FIG. 1B is a schematic diagram describing an example use of an alert control apparatus according to one or more embodiments of the present invention;

FIG. 2 is a schematic diagram of a vehicle including an alert control apparatus according to a first embodiment of the present invention;

FIG. 3 is a block diagram of the alert control apparatus shown in FIG. 2;

FIG. 4 is a schematic diagram describing example predetermined retention allowable durations included in a determination criterion;

FIG. 5 is a flowchart showing an example procedure and operation performed by the alert control apparatus shown in FIG. 3;

FIG. 6 is a diagram describing example retention allowable durations shortened in response to recognition of a railroad crossing;

FIG. 7 is a flowchart showing an example procedure and operation performed by an alert control apparatus according to a second embodiment of the present invention; and

FIG. 8 is a diagram describing example extended retention allowable durations.

### DETAILED DESCRIPTION

One or more embodiments of the present invention will now be described with reference to the drawings.

### Example Use

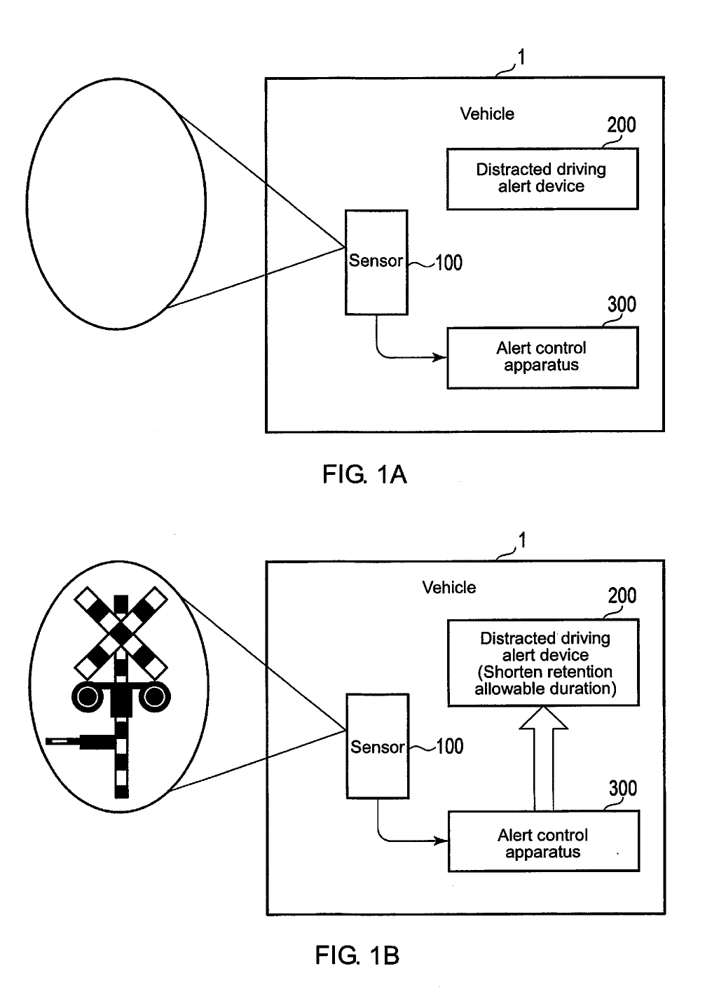

An example use of an alert control apparatus according to one or more embodiments of the present invention will now be described. FIGS. 1A and 1B are schematic diagrams describing an example use of the alert control apparatus according to the present embodiment.

A vehicle 1 includes an alert control apparatus 300 in addition to a sensor 100 and a distracted driving alert device 200. The sensor 100 obtains data about, for example, environments outside and inside the vehicle 1 and the conditions of the driver. For example, the sensor 100 obtains various items of sensing data with, for example, an exterior view camera, an interior view camera, a position measurement sensor such as a global positioning system (GPS) sensor, and a wireless beacon receiver.

The sensing data is transferred to the alert control apparatus 300. The alert control apparatus 300 processes image data from the interior view camera to detect the gaze direction or the face orientation of the driver, and causes the distracted driving alert device 200 to generate an alert to distracted driving based on the detection result.

As shown in FIG. 1A, the alert control apparatus 300 controls the distracted driving alert device 200 to generate an alert to distracted driving when the gaze or face orientation of the driver is retained in a direction other than the traveling direction for a predetermined duration (e.g., several seconds). The alert may be a voice message stating, for example, “Stay alert, and keep your eyes on the road.”

When the sensor 100 detects a railroad crossing as shown in FIG. 1B, the alert control apparatus 300 controls the distracted driving alert device 200 to change a determination criterion for generating an alert to distracted driving.

An alert control operation described below is performed in response to detection of a railroad crossing.

The alert control apparatus 300 determines whether the vehicle 1 is approaching a railroad crossing using position data about the vehicle 1 obtained from a GPS sensor 12 and map data prestored in, for example, a car navigation system. When determining that the vehicle 1 is approaching a railroad crossing, the alert control apparatus 300 shortens the duration for which the gaze is allowed to be in a direction other than the traveling direction (retention allowable duration) and uses the shortened duration while the vehicle 1 is passing the railroad crossing.

In this state, the driver looking in the same lateral direction longer than a predetermined duration at the railroad crossing will receive an alert. This prompts the driver to frequently move his or her gaze while the vehicle 1 is passing the railroad crossing, and thus to look in multiple directions for safety checking instead of looking in a single direction while passing the railroad crossing.

### First Embodiment

### Structure

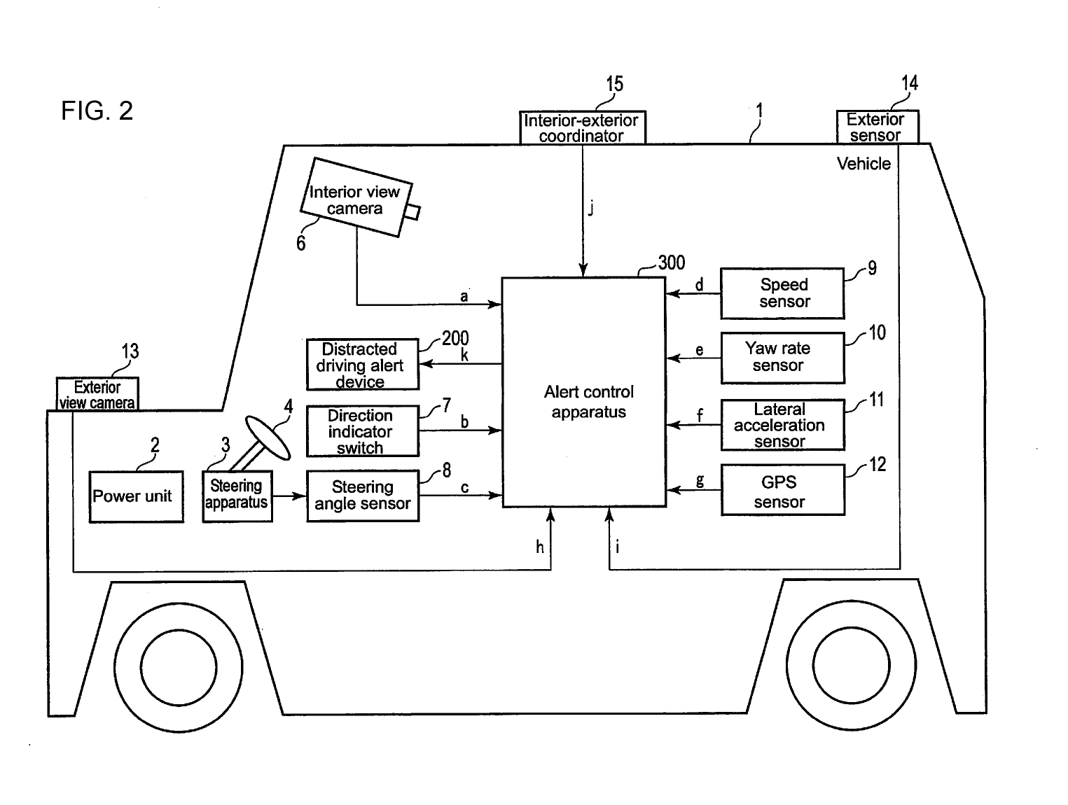

FIG. 2 is a schematic diagram of a vehicle including an alert control apparatus according to a first embodiment. The vehicle 1 includes, as its basic components, a power unit 2 including a power supply and a transmission, and a steering apparatus 3 incorporating a steering wheel 4. The vehicle 1 further includes, as processing blocks according to the embodiment, the alert control apparatus 300, an interior view camera 6, a direction indicator switch 7, a steering angle sensor 8, a speed sensor 9, a yaw rate sensor 10, a lateral acceleration sensor 11, a position measurement sensor, such as the GPS sensor 12, an exterior view camera 13, an exterior sensor 14, an interior-exterior coordinator 15, and the distracted driving alert device 200.

The alert control apparatus 300 obtains data, such as image data, sensing data, and reception data, from the interior view camera 6, the direction indicator switch 7, the steering angle sensor 8, the speed sensor 9, the yaw rate sensor 10, the lateral acceleration sensor 11, the GPS sensor 12, the exterior view camera 13, the exterior sensor 14, and the interior-exterior coordinator 15. The alert control apparatus 300 causes the distracted driving alert device 200 to generate an alert when detecting, based on the data items, distracted driving of the driver while the vehicle 1 is traveling straight.

The alert control apparatus 300 determines distracted driving by, for example, determining whether the face orientation or gaze direction of the driver of the vehicle 1 is continuously retained in a predefined distracted driving determinant area longer than for a predetermined duration. The determination criteria may also include the speed and the steering angle of the vehicle 1.

The distracted driving alert device 200 is installed in the vehicle interior. The distracted driving alert device 200 includes, for example, a speaker that outputs an alert sound or an alert voice message, a display for displaying an alert massage, or a vibrator that provides a vibrating alert. The distracted driving alert device 200 generates an alert in response to a warning instruction signal k output from the alert control apparatus 300. The distracted driving alert device 200 may also be a mobile terminal.

The interior view camera 6 faces the driver to capture an image of, for example, the upper body of the driver, and outputs an image data signal a to the alert control apparatus 300. The interior view camera 6 may capture images of the driver constantly either while the vehicle 1 is operating or in response to a request from the alert control apparatus 300.

The direction indicator switch 7 outputs, to the alert control apparatus 300, a direction indicator signal b corresponding to a direction in which the driver intentionally redirects the vehicle 1 to turn right or left or to change the lane.

The steering angle sensor 8 outputs, to the alert control apparatus 300, a steering angle signal c corresponding to the steering direction, the neutral position, and the steering angle in accordance with the operation of the steering apparatus 3.

The speed sensor 9 detects the speed of the vehicle 1, and outputs a detection signal d corresponding to the detected speed to the alert control apparatus 300.

The yaw rate sensor 10 detects the yaw rate of the vehicle 1, and outputs a detection signal e corresponding to the detected yaw rate to the alert control apparatus 300.

The lateral acceleration sensor 11 detects a lateral acceleration of the vehicle 1, and outputs a detection signal f corresponding to the detected lateral acceleration to the alert control apparatus 300.

The GPS sensor 12 detects position data about the vehicle 1 based on position measurement signals transmitted from multiple GPS satellites, and outputs a detection signal g including the detected position data to the alert control apparatus 300. A future example of the GPS sensor 12 may be a positioning system using quasi-zenith satellites called a Japanese version GPS.

The exterior view camera 13 captures images in front of the vehicle 1, and outputs an image data signal h including the image data to the alert control apparatus 300.

The exterior sensor 14 includes, for example, an acoustic sensor, a humidity sensor, a temperature sensor, an infrared sensor, or a radar. The exterior sensor 14 is installed at the vehicle exterior to output a sensing signal i corresponding to detected values to the alert control apparatus 300.

The interior-exterior coordinator 15 receives an external signal transmitted wirelessly including surrounding data about the vehicle 1, such as traffic jam information and map data. The interior-exterior coordinator 15 outputs a received signal j to the alert control apparatus 300. Such surrounding data is provided by a vehicle-to-roadside communication system, such as the Vehicle Information and Communication System (VICS, registered trademark) in Japan. In some embodiments, the surrounding data may be transmitted from a beacon, such as a radio wave beacon, installed near a railroad crossing. In some embodiments, the surrounding data may be transmitted from oncoming vehicles through a vehicle-to-vehicle communication system.

The distracted driving alert device 200 is installed in the vehicle interior to generate an alert in response to the warning instruction signal k from the alert control apparatus 300. Examples of an alert include, in addition to a buzzer sound, a display, light emission, vibrations, and communication to mobile terminals.

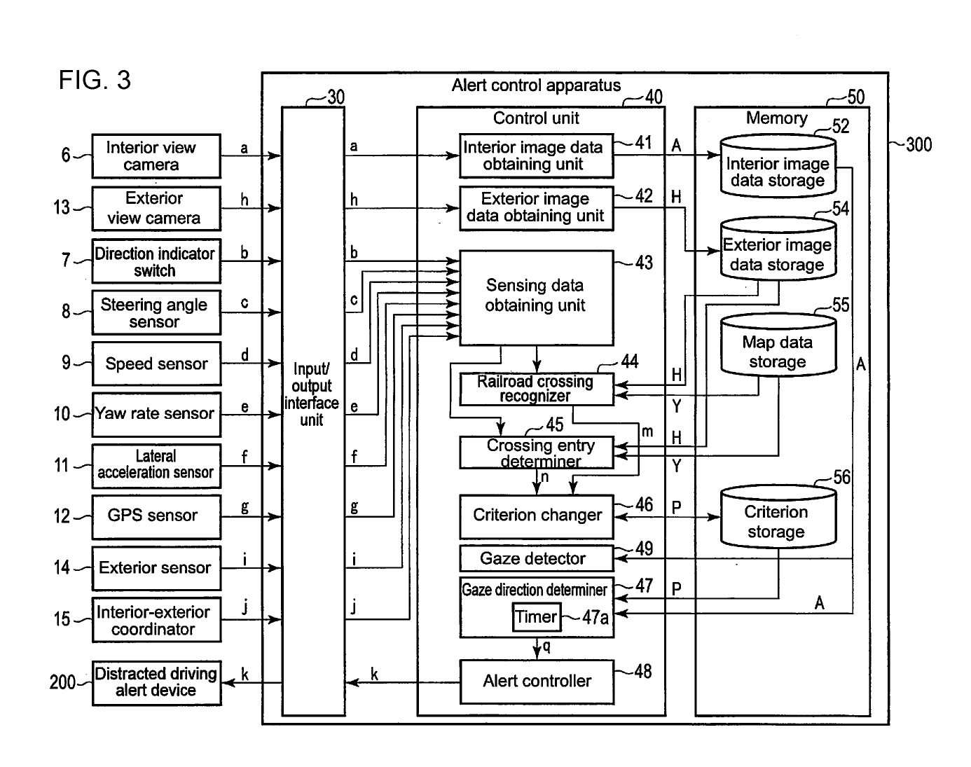

FIG. 3 is a block diagram of the alert control apparatus 300 according the present embodiment. The alert control apparatus 300 is a computer including a central processing unit (CPU) and a memory. The alert control apparatus 300 includes an input/output interface unit 30, a control unit 40, and a memory 50.

The input/output interface unit 30 receives the image data signal a from the interior view camera 6, the direction indicator signal b from the direction indicator switch 7, the steering angle signal c from the steering angle sensor 8, the detection signal d from the speed sensor 9, the detection signal e from the yaw rate sensor 10, the detection signal f from the lateral acceleration sensor 11, the detection signal g from the GPS sensor 12, the image data signal h from the exterior view camera 13, the sensing signal i from the exterior sensor 14, and the received signal j from the interior-exterior coordinator 15. The input/output interface unit 30, for example, buffers these signals and then transfers them to the control unit 40. The input/output interface unit 30 also outputs a warning instruction signal k received from the control unit 40 to the distracted driving alert device 200.

The memory 50 is, for example, a semiconductor memory, such as a random access memory (RAM), a read only memory (ROM), a flash memory, and a synchronous dynamic RAM (SDRAM), or a non-volatile memory, such as an erasable programmable ROM (EPROM). The memory 50 may also be a storage medium, such as a solid state drive (SSD) and a hard disk drive (HDD). In some embodiments, the memory 50 may be a storage area included in a one-chip microcomputer, such as a field programmable gate array (FPGA).

The memory 50 includes, as storage areas according to the embodiment, an interior image data storage 52, an exterior image data storage 54, and a criterion storage 56.

The control unit 40 includes, as functional blocks according to the embodiment, an interior image data obtaining unit 41, an exterior image data obtaining unit 42, a sensing data obtaining unit 43, a railroad crossing recognizer 44, a crossing entry determiner 45, a criterion changer 46, a gaze direction determiner 47, an alert controller 48, and a gaze detector 49. These functional blocks are implemented by the CPU executing programs stored in the program memory.

The interior image data obtaining unit 41 receives the image data signal a transmitted from the interior view camera 6 and output from the input/output interface unit 30, and stores the signal into the interior image data storage 52 as image data A. Thus, the interior image data storage 52 stores the image data A representing the state of the driver.

The exterior image data obtaining unit 42 receives the image data signal h transmitted from the exterior view camera 13 and output from the input/output interface unit 30, and stores the signal into the exterior image data storage 54 as image data H. Thus, the exterior image data storage 54 stores the image data H representing the state of an area in front of the vehicle 1.

The gaze detector 49 detects the gaze or face orientation of the driver from the image data A stored in the interior image data storage 52.

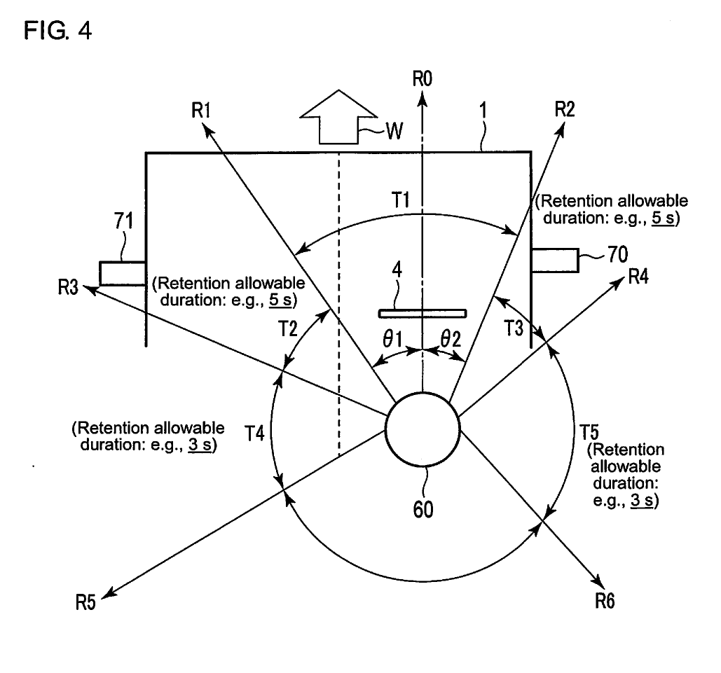

The gaze direction determiner 47 outputs a signal q to the alert controller 48 when detecting distracted driving of the driver 60 based on the gaze or face orientation of the driver detected by the gaze detector 49 and a criterion P stored in the criterion storage 56. The criterion P will now be described with reference to FIG. 4.

FIG. 4 is a schematic diagram describing retention allowable durations as one example of the criterion P. FIG. 4 is a schematic diagram of the vehicle interior viewed from above. FIG. 4 includes a right side mirror 70 and a left side mirror 71.

When the vehicle 1 is traveling straight forward (or upward in the figure) at a normal speed (e.g., 60 km per hour), the gaze direction R of the driver 60 is typically parallel to the traveling direction W of the vehicle 1 or points straight ahead in a gaze direction R0. In this case, the gaze direction R is expected not to deviate leftward from a gaze direction R1 or rightward from a gaze direction R2, although it can slightly move leftward or rightward from the gaze direction R0. A spatial area T1 extends in front of the driver 60.

The driver 60 having his or her gaze direction R within a spatial area different from the area T1 is determined to be engaging in distracted driving. This spatial area is in the direction in which the driver 60 is distracted, or is looking aside (distracted driving direction). The area in the distracted driving direction is not limited to a single area. As shown FIG. 4, four areas T2 to T5 may be defined in the distracted driving direction. The area T2 is on the left of and adjacent to the area T1. The area T3 is on the right of and adjacent to the area T1. The area T4 is on the rear of and adjacent to the area T2. The area T5 is on the rear of and adjacent to the area T3.

In the example shown in FIG. 4, the area T2 between the gaze directions R1 and R3 and the area T3 between the gaze directions R2 and R4 are asymmetric with respect to the gaze direction R0, and the area T4 between the gaze directions R3 and R5 and the area T5 between the gaze directions R4 and R6 are also asymmetric with respect to the gaze direction R0.

FIG. 4 shows the settings applicable to regions with left-hand traffic. In this example, an angle θ1 between the gaze directions R0 and R1 is greater than an angle θ2 between the gaze directions R0 and R2. The relationship between these angles is reversed in regions with right-hand traffic.

The driver with his or her gaze direction R retained within any of the areas T2 to T5 is determined not to be engaging in distracted driving when the driver changes his or her gaze direction R to another area or to the area T1 in a short time. The length of the retention time set for each area for distracted driving determination herein refers to a retention allowable duration. In other words, the retention allowable duration refers to a duration for which the driver 60 is allowed to retain his or her gaze direction R within the same area without activating the distracted driving alert device 200.

The retention allowable duration can be set for each area. In FIG. 4, the retention allowable duration is set at five seconds for the area T2, five seconds for the area T3, three seconds for the area T4, and three seconds for the area T5. The retention allowable durations are shortened from predetermined values (default values) when the vehicle 1 passes a railroad crossing. In the present embodiment, the retention allowable durations shown in FIG. 4 are predetermined values.

The gaze direction determiner 47 obtains the image data A from the interior image data storage 52 and the criterion P from the criterion storage 56, and determines distracted driving of the driver 60 based on the image data A and the criterion P. More specifically, the gaze direction determiner 47 does not detect distracted driving when the gaze direction R determined from the face orientation or gaze of the driver 60 in the image data A is within the area T1.

When the gaze direction R is within any of the areas T2 to T5, the gaze direction determiner 47 activates a built-in timer 47a. The timer 47a then counts the time for which the gaze direction R is retained within the same area. The gaze direction determiner 47 determines whether the count reaches the retention allowable duration set for the corresponding area.

When the driver 60 changes his or her gaze direction R to another area or to the area T1 before the count reaches the retention allowable duration, the gaze direction determiner 47 stops the timer 47a and resets the count.

When the count of the timer 47a reaches the retention allowable duration of the corresponding one of the areas T2 to T5, the gaze direction determiner 47 detects distracted driving, and outputs an activation signal q to the alert controller 48 to activate the distracted driving alert device 200.

In response to the activation signal q output from the gaze direction determiner 47, the alert controller 48 outputs the warning instruction signal k to the input/output interface unit 30. The input/output interface unit 30 outputs the warning instruction signal k to the distracted driving alert device 200.

In response to the warning instruction signal k output from the input/output interface unit 30, the distracted driving alert device 200 generates an alert. When the vehicle 1 has not entered a railroad crossing, the distracted driving alert device 200 generates an alert to distracted driving under control by the alert controller 48. In contrast, either immediately before the vehicle 1 enters a railroad crossing or at least while the vehicle 1 is passing a railroad crossing, the control unit 40 restricts alert generation from the distracted driving alert device 200.

The sensing data obtaining unit 43 receives the direction indicator signal b, the steering angle signal c, the detection signal d, the detection signal e, the detection signal f, the detection signal g, the sensing signal i, and the received signal j output from the input/output interface unit 30, and outputs these signals to the railroad crossing recognizer 44 and the crossing entry determiner 45.

The railroad crossing recognizer 44 recognizes the position of a railroad crossing relative to the vehicle 1 based on at least one of position information G, traffic and other information J, the image data H stored in the exterior image data storage 54, and map data Y stored in a map data storage 55. When the image data H is used, the gate of the crossing may be recognized using Open Source Computer Vision Library (OpenCV) to recognize, for example, the position of the crossing relative to the vehicle 1. After recognizing a railroad crossing, the railroad crossing recognizer 44 outputs a crossing recognition signal m to the criterion changer 46.

The crossing entry determiner 45 determines whether the vehicle 1 has entered a railroad crossing based on at least one of the position information G, the map data Y from the map data storage 55, the traffic and other information J, and the image data H from the exterior image data storage 54. When detecting entry of the vehicle 1 into the railroad crossing, the crossing entry determiner 45 outputs a determination signal n to the criterion changer 46.

When receiving the determination signal n from the crossing entry determiner 45, the criterion changer 46 obtains the criterion P from the criterion storage 56, tightens the criterion P, and then returns it to the criterion storage 56. The criterion P stored in the criterion storage 56 is updated accordingly.

Tightening the criterion P includes shortening the retention allowable durations from the predetermined values shown in, for example, FIG. 4. Shortening the retention allowable durations prompts the driver to move his or her gaze laterally. More embodiments based on the above structure will now be described.

### Operation

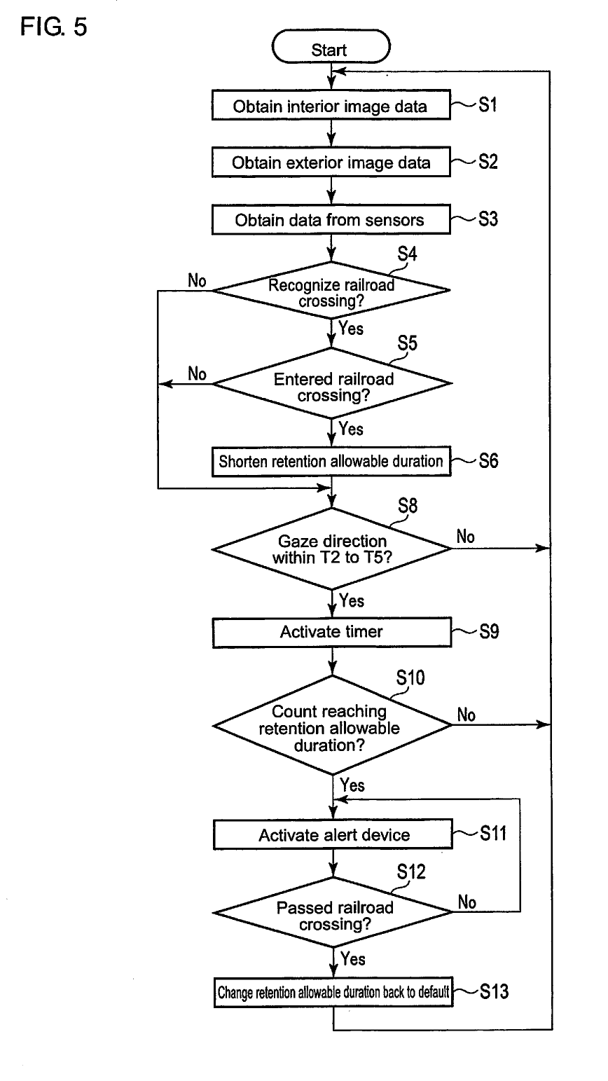

FIG. 5 is a flowchart showing an example procedure and operation performed by the alert control apparatus according to the first embodiment. In FIG. 5, the interior view camera 6 captures images of the driver 60, and outputs the image data signal a to the alert control apparatus 300. The image data signal a is transferred to the interior image data obtaining unit 41 through the input/output interface unit 30, and is converted into the image data A and stored in the interior image data storage 52 (S1).

The exterior view camera 13 captures images in front of the vehicle 1, and outputs the image data signal h to the alert control apparatus 300. The image data signal h is transferred to the exterior image data obtaining unit 42 through the input/output interface unit 30, and is converted into the image data H and stored in the exterior image data storage 54 (S2).

Further, the signals corresponding to the results detected by the direction indicator switch 7, the steering angle sensor 8, the speed sensor 9, the yaw rate sensor 10, the lateral acceleration sensor 11, the GPS sensor 12, and the exterior sensor 14, as well as the received signal received by the interior-exterior coordinator 15 are also output to the alert control apparatus 300. These signals are obtained by the sensing data obtaining unit 43 through the input/output interface unit 30 (S3).

Through the above processing, the sensing data obtaining unit 43 receives direction indicator information B from the direction indicator signal b, steering angle information C from the steering angle signal c, speed information ID from the detection signal d, yaw rate information E from the detection signal e, lateral acceleration information F from the detection signal f, the position information G from the detection signal g, distance information I from the sensing signal i, and the traffic and other information J from the received signal j. Steps S1 to S3 may not be performed in the order illustrated in the figure. In the processing performed by the processor, steps S1 to S3 are performed substantially in parallel.

For a railroad crossing in front of the vehicle 1 in the traveling direction, the railroad crossing recognizer 44 recognizes the railroad crossing based on at least one of the position information G, the traffic and other information J, the image data H, and the map data Y (Yes in step S4). The railroad crossing recognizer 44 then outputs the crossing recognition signal m to the criterion changer 46. The processing then advances to the step S5.

When no railroad crossing is in front of the vehicle 1 in the traveling direction, the railroad crossing recognizer 44 does not recognize any railroad crossing (No in step S4). The processing then advances to step S8.

In step S5, the crossing entry determiner 45 determines whether the vehicle 1 enters the crossing (S5). The crossing entry determiner 45 detects entry into the railroad crossing based on comparison between the position data about the vehicle 1 and the position data about the railroad crossing recorded in the map data (Mode 1).

In some embodiments, the crossing entry determiner 45 detects entry into the railroad crossing based on the exterior image data H that has undergone image processing (Mode 2).

In some embodiments, the crossing entry determiner 45 detects entry into the railroad crossing based on the surrounding data about the vehicle 1 obtained by the interior-exterior coordinator 15 (Mode 3).

When the crossing entry determiner 45 detects no entry of the vehicle 1 into the crossing in step S5 (No in step S5), the gaze direction determiner 47 determines the gaze direction R of the driver 60 from the face orientation or gaze of the driver 60 in the image data A (S8). When the gaze direction R is not retained within any of the areas T2 to T5 (No in step S8), the gaze direction determiner 47 determines not to activate the distracted driving alert device 200. The processing then returns to step S1.

When the gaze direction R is retained within any of the areas T2 to T5 (Yes in step S8), the gaze direction determiner 47 activates the timer 47a (S9). The timer 47a then counts the time for which the gaze direction R is retained within the same area. The gaze direction determiner 47 then determines whether the count reaches the retention allowable duration set for the corresponding area (S10).

When the driver 60 changes his or her gaze direction R to another area or to the area T1 before the count reaches the retention allowable duration (No in step S10), the count is reset. The processing then returns to step S1. In this case, no alert is generated.

When the count of the timer 47a reaches the retention allowable duration (Yes in step S10), the gaze direction determiner 47 outputs the activation signal q to the alert controller 48. In response to the activation signal q, the alert controller 48 outputs the warning instruction signal k to the distracted driving alert device 200 through the input/output interface unit 30. The distracted driving alert device 200 generates an alert (S11).

In step S5, when the crossing entry determiner 45 detects entry of the vehicle 1 into the railroad crossing based on any of the modes 1 to 3 or any combination of these (Yes in step S5), the crossing entry determiner 45 outputs the determination signal n to the criterion changer 46. The criterion changer 46 then shortens the retention allowable duration set for each area T2 to T5 shown in FIG. 4 (S6).

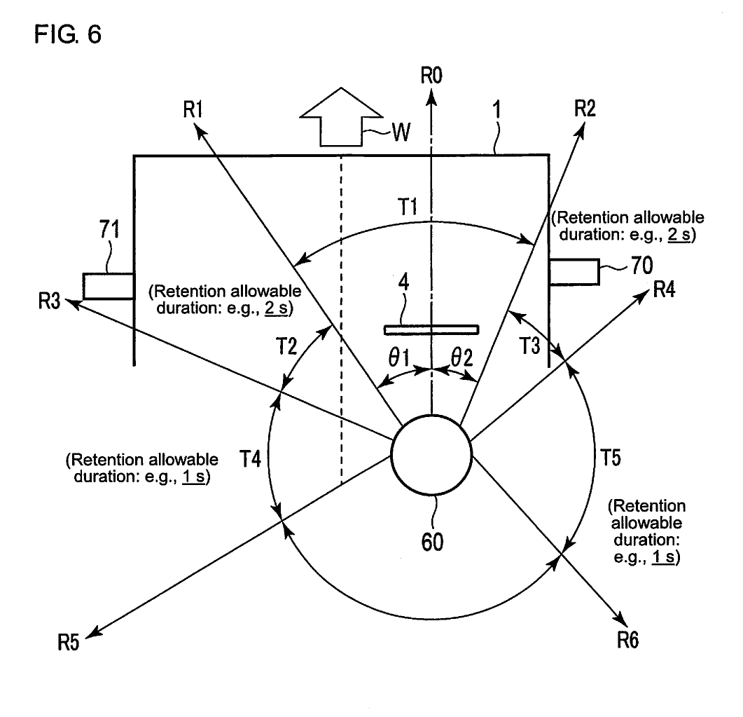

FIG. 6 is a diagram describing an example of shortened retention allowable durations. For the areas T2 and T3, the retention allowable duration of five seconds at default is set to, for example, two seconds. For the areas T4 and T5, the retention allowable duration of three seconds at default is set to, for example, one second. More specifically, when the entry into the railroad crossing is detected, step S8 and subsequent steps are performed using the criterion P changed in step S6.

When the gaze direction R is retained within any of the areas T2 to T5 in step S8 (Yes in step S8), the timer 47a is activated (S9). The timer 47a then counts the time for which the gaze direction R is retained within the same area. The gaze direction determiner 47 then determines whether the count reaches the retention allowable duration set for the corresponding area (S10). When the gaze moves before the count reaches the retention allowable duration (No in step S10), the processing returns to step S1. In this case, step S11 is skipped, and no alert is generated.

With the retention allowable durations shortened in step S6, the count has a shorter time before reaching the retention allowable duration, and reaches a full count earlier than at usual times. When the count of the timer 47a reaches the retention allowable duration (Yes in step S10), the gaze direction determiner 47 outputs the activation signal q to the alert controller 48. In response to the activation signal q, the alert controller 48 outputs the warning instruction signal k to the distracted driving alert device 200 through the input/output interface unit 30. The distracted driving alert device 200 generates an alert (S11).

When the crossing entry determiner 45 detects that the vehicle 1 has passed the railroad crossing in step S12, the criterion changer 46 changes the determination criterion changed in step S6 back to the default values (S13).

### Advantages and Effects

In the present embodiment described above, the retention allowable durations set for the areas T2 to T5 are shortened from the predetermined values while the vehicle is passing the railroad crossing. This structure alerts a driver looking too long in one direction at a railroad crossing, and prompts the driver to frequently move his or her gaze laterally. The alert control apparatus according to the present embodiment effectively prompts, with the distracted driving alert device, the driver of a vehicle passing a railroad crossing to look to the right and left for safety checking, and contributes to safe driving of the driver.

In the above embodiment, the determination criterion for distracted driving is changed in step S6 upon detection of the vehicle 1 entering a railroad crossing. In actual operations, the determination criterion for distracted driving is changed when the vehicle 1 reaches a stop position before entering a railroad crossing. This allows the driver to reliably look to the right and left for safety checking before the vehicle 1 enters the railway crossing.

### Second Embodiment

### Structure

An alert control apparatus according to a second embodiment changes the determination criterion for distracted driving based on the speed of the vehicle 1 and the distance between the vehicle 1 and its preceding vehicle, and controls the determination criterion based on recognition of a railroad crossing with precedence over the determination criterion based on the vehicle speed and the distance from the preceding vehicle. The alert device in the second embodiment has basically the same structure as the alert device in the first embodiment, and will be described with reference to FIGS. 2 and 3.

### Operation

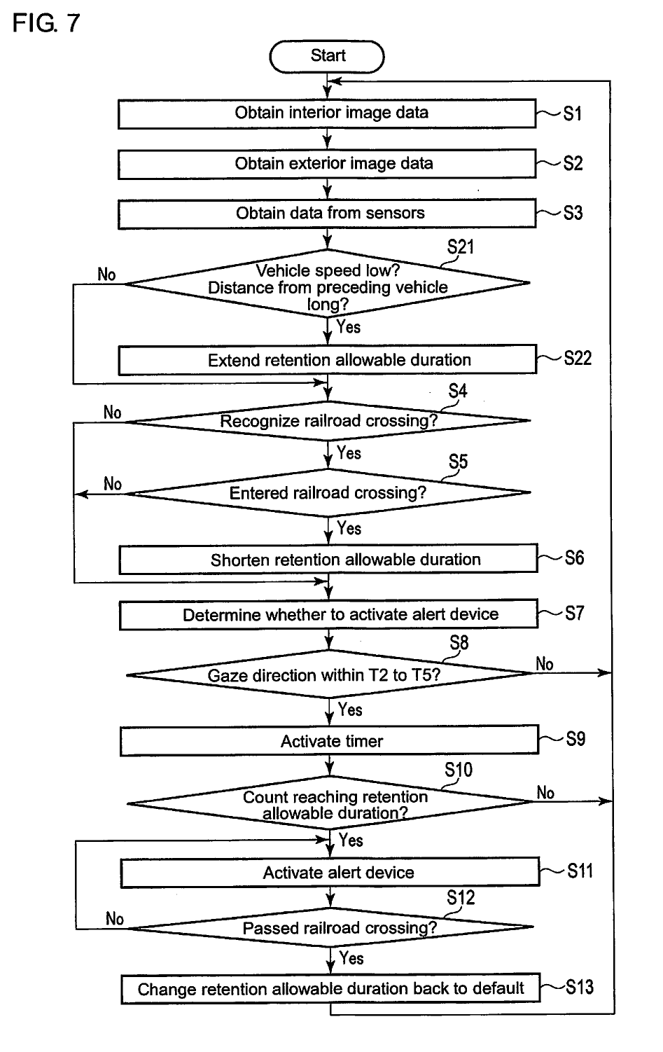

FIG. 7 is a flowchart showing an example procedure and operation performed by the alert control apparatus according to the second embodiment. In FIG. 7, the control unit 40 obtains the interior image data A (S1), obtains the exterior image data H (S2), and obtains the signals corresponding to the results detected by the direction indicator switch 7, the steering angle sensor 8, the speed sensor 9, the yaw rate sensor 10, the lateral acceleration sensor 11, the GPS sensor 12, and the exterior sensor 14, and the received signal received by the interior-exterior coordinator 15 (S3). The control unit 40 then determines the speed of the vehicle 1 based on the speed information D output from the sensing data obtaining unit 43. The control unit 40 further determines the distance between the vehicle 1 and the preceding vehicle based on the distance information I obtained from the sensing signal i and output from the sensing data obtaining unit 43 or the image data H obtained from the exterior image data storage 54.

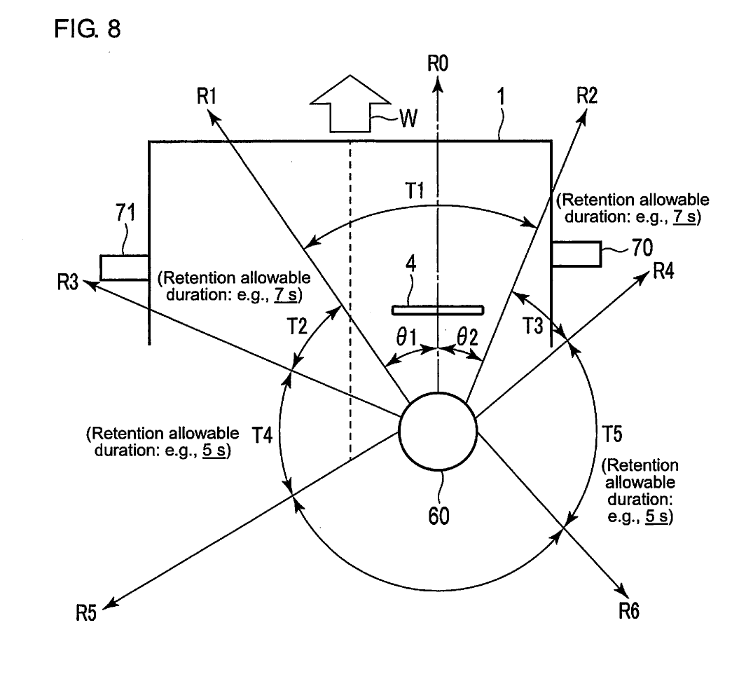

When the speed of the vehicle 1 is determined to be lower than the predetermined speed and the distance between the vehicle 1 and the preceding vehicle is determined to be longer than the predetermined distance (Yes in S21), the control unit 40 relaxes the criterion P stored in the criterion storage 56. More specifically, the control unit 40 extends the retention allowable durations from the predetermined values shown in FIG. 4 to the values shown in FIG. 8 (S22).

FIG. 8 is a diagram describing example extended retention allowable durations. For the areas T2 and T3, the retention allowable duration of five seconds at default is set to, for example, seven seconds. For the areas T4 and T5, the retention allowable duration of three seconds at default is set to, for example, five seconds. More specifically, the control unit 40 relaxes the determination criterion for distracted driving when detecting that the speed of the vehicle is low or the distance from the preceding vehicle is long.

After step S22 in FIG. 7, step S4 and subsequent steps are performed in the same manner as the steps in the first embodiment. Through the above processing, the structure according to the second embodiment uses the distracted driving determination criterion set for a railroad crossing although the speed of the vehicle 1 is lower than the predetermined speed or the distance between the vehicle 1 and the preceding vehicle is longer than the predetermined distance (Yes in step S21). More specifically, the determination criterion for distracted driving tighter than the default is used while the vehicle 1 is passing a railroad crossing.

### Advantages and Effects

In the second embodiment described above, the determination criterion relaxed based on at least the speed of the vehicle 1 or the distance from the preceding vehicle is tightened while the vehicle 1 is passing a railroad crossing. Thus, the distracted driving alert device 200 prompts the driver 60 to check the surroundings while passing the railroad crossing to improve safety.

The alert control apparatus according to each of the above embodiments and its components may be implemented by hardware or a combination of hardware resources and software. The software to be combined is a program preliminarily installed in a computer through a network or from a computer readable recording medium, and executed by a processor included in the computer to perform the operation of each unit.

A processor used in association with a computer or the term processor herein includes a circuit such as a CPU, a graphics processing unit (GPU), an application specific integrated circuit (ASIC), a simple programmable logic device (SPLD), a complex programmable logic device (CPLD), and an FPGA.

The processor reads a program stored in the memory and executes the program to implement the specific processing based on the program. The program may not be stored in the memory but may be directly incorporated in the circuit of the processor. In that case, the processor reads the program incorporated in the circuit to perform the processing.

Although the present invention has been described based on the specific embodiments with reference to the appended drawings, the present invention is not limited to the above embodiments. Variations and modifications will occur to those skilled in the art within the spirit and scope of the present invention defined by the claims. Such variations and modifications can fall within the technical scope of the present invention.

The present embodiment may be partially or entirely expressed in, but not limited to, the following forms shown in the appendix below in addition to the claims.

### APPENDIX 1

An alert control apparatus for causing an alert device to generate an alert to distracted driving based on a gaze or a face orientation of a driver of a vehicle, the apparatus comprising a hardware processor configured to

obtain sensing data from a sensor included in the vehicle;

detect the gaze or the face orientation of the driver based on the obtained sensing data;

determine distracted driving of the driver based on the detected gaze or face orientation and a determination criterion for detecting distracted driving of the driver;

cause the alert device to generate an alert in response to detection of distracted driving;

recognize a position of a railroad crossing relative to the vehicle based on the obtained sensing data; and

change, based on a recognition result indicating the position of the railroad crossing, the determination criterion to a criterion with which the alert is more likely to be generated while the vehicle is passing the railroad crossing than at other times.

### APPENDIX 2

An alert control method implemented by an alert control apparatus installable in a vehicle to control an alert device that alerts a driver, the method comprising:

obtaining, with at least one hardware processor, sensing data from a sensor included in the vehicle;

detecting, with the at least one hardware processor, a gaze or a face orientation of the driver based on the obtained sensing data;

determining, with the at least one hardware processor, distracted driving of the driver based on the detected gaze or face orientation and a determination criterion for detecting distracted driving of the driver;

causing, with the at least one hardware processor, the alert device to generate an alert in response to detection of distracted driving;

recognizing, with the at least one hardware processor, a position of a railroad crossing relative to the vehicle based on the obtained sensing data; and

changing, with the at least one hardware processor, based on a recognition result indicating the position of the railroad crossing, the determination criterion to a criterion with which the alert is more likely to be generated while the vehicle is passing the railroad crossing than at other times.

1. An alert control apparatus installable in a vehicle to control an alert device that alerts a driver, the apparatus comprising:
a data obtaining unit configured to obtain sensing data from a sensor included in the vehicle;
a gaze detector configured to detect a gaze or a face orientation of the driver based on the obtained sensing data;
a distracted driving determiner configured to determine distracted driving of the driver based on the detected gaze or face orientation and a determination criterion for detecting distracted driving of the driver;
a controller configured to cause the alert device to generate an alert in response to detection of distracted driving;
a railroad crossing recognizer configured to recognize a position of a railroad crossing relative to the vehicle based on the obtained sensing data; and
a changer configured to change, based on a recognition result from the railroad crossing recognizer, the determination criterion to a criterion with which the alert is more likely to be generated while the vehicle is passing the railroad crossing than at other times.

2. The alert control apparatus according to claim 1, wherein
the determination criterion is changeable based on at least a speed of the vehicle or a distance from a preceding vehicle, and
the changer changes the determination criterion based on the recognition result from the railroad crossing recognizer with precedence over the speed of the vehicle and the distance from the preceding vehicle.

3. The alert control apparatus according to claim 1, wherein
the determination criterion includes a retention allowable duration for which the driver is allowed to retain a gaze or a face orientation within a determinant area imaginarily defined for detecting distracted driving, and
the changer shortens the retention allowable duration to retain the gaze or the face orientation within the determinant area while the vehicle is passing the railroad crossing from a retention allowable duration used at other times.

4. The alert control apparatus according to claim 1, further comprising:
a storage configured to store map data including at least position data about the railroad crossing, wherein
the sensing data includes position data about the vehicle,
the data obtaining unit obtains the position data about the vehicle based on a positioning signal from a positioning system, and
the railroad crossing recognizer recognizes the position of the railroad crossing relative to the vehicle based on the obtained position data about the vehicle and the position data about the railroad crossing included in the map data.

5. The alert control apparatus according to claim 1, wherein
the vehicle includes an exterior view camera configured to obtain image data external to the vehicle,
the data obtaining unit obtains the image data from the exterior view camera, and
the railroad crossing recognizer subjects the image data to image processing, and uses the processed image data to recognize the position of the railroad crossing relative to the vehicle.

6. The alert control apparatus according to claim 1, wherein
the vehicle is configured to communicate with a vehicle-to-roadside communication system or a vehicle-to-vehicle communication system,
the data obtaining unit obtains surrounding data about the vehicle from the communication system, and
the railroad crossing recognizer recognizes the position of the railroad crossing relative to the vehicle based on the surrounding data.

7. An alert control method implemented by an alert control apparatus installable in a vehicle to control an alert device that alerts a driver, the method comprising:
obtaining, with the alert control apparatus, sensing data from a sensor included in the vehicle;
detecting, with the alert control apparatus, a gaze or a face orientation of the driver based on the obtained sensing data;
determining, with the alert control apparatus, distracted driving of the driver based on the detected gaze or face orientation and a determination criterion for detecting distracted driving of the driver;
causing, with the alert control apparatus, the alert device to generate an alert in response to detection of distracted driving;
recognizing, with the alert control apparatus, a position of a railroad crossing relative to the vehicle based on the obtained sensing data; and
changing, with the alert control apparatus, based on a recognition result indicating the position of the railroad crossing, the determination criterion in a manner to a criterion with which the alert is more likely to be generated while the vehicle is passing the railroad crossing than at other times.

8. A non-transitory recording medium having a program recorded thereon that is executable to cause a computer to implement processes performed by the units included in the alert control apparatus according to claim 1.

9. A non-transitory recording medium having a program recorded thereon that is executable to cause a computer to implement processes performed by the units included in the alert control apparatus according to claim 2.

10. A non-transitory recording medium having a program recorded thereon that is executable to cause a computer to implement processes performed by the units included in the alert control apparatus according to claim 3.

11. A non-transitory recording medium having a program recorded thereon that is executable to cause a computer to implement processes performed by the units included in the alert control apparatus according to claim 4.

12. A non-transitory recording medium having a program recorded thereon that is executable to cause a computer to implement processes performed by the units included in the alert control apparatus according to claim 5.

13. A non-transitory recording medium having a program recorded thereon that is executable to cause a computer to implement processes performed by the units included in the alert control apparatus according to claim 6.
